(19) United States
(12) Patent Application Publication
(10) Pub. No.: US 2006/0184884 A1
(43) Pub. Date: Aug. 17, 2006

(54) Virtual window and room treatments

(76) Inventor: Prateek A. Chaturvedi, Dallas, TX (US)

Correspondence Address: PRATEEK A CHATURVEDI, 7575 FRANKFORD ROAD #1611, DALLAS, TX, 75252, US

(21) Appl. No.: 11/352,532

(22) Filed: Feb. 13, 2006

Related U.S. Application Data
(60) Provisional application No. 60/652,979, filed on Feb. 15, 2005.

(51) Int. Cl. G06F 17/00

(52) U.S. Cl. 715/751

(57) ABSTRACT

An online interface allowing designers, end users and store representatives, etc. . . . involved in material selection process for window treatment, furniture, wall finish, flooring, accessories, interior designing etc. . . . to select different materials from catalog books by multiple suppliers, view effects of it's combinations and exchange opinions while observing one another's selections simultaneously on their individual computers, even if every one involved in the process are located at completely different locations. An online interface combined with a Three Dimensional Virtual Reality Viewer allowing users to build new ambience or reproduce the existing ambience and place desired window treatment, flooring, wall finish, accessories, furniture, interior designing objects from different suppliers in combination of one another with selected finishing materials to view final effects of individual material on desired object as well as the combination of multiple objects with selected materials with multiple views.

This application claims priority to provisional application per U.S. Patent (U.S. 60/652,979), “Virtual drapes and room”, which is incorporated herein by reference.

### BACKGROUND OF THE INVENTION

At present interior designers, store representatives and end user customers and other entities involved in the process of selecting materials for window treatment, wall finish, flooring and furniture face following problems in the selection process, as described in Para 2 to 9 hereafter.

It is impossible for customers to sort through all available samples to find only the samples that meet their basic criteria for further short-listing, without spending tremendous amount of time.

It is extremely difficult for customers to visualize final effects of a material when it is applied as a finish over a larger area in the form of window treatment, furniture treatment, flooring &/or wall covering at their location, only by looking at a small material sample swatch.

It is almost impossible for customers to visualize final effects of the over all combination of window treatment fabrics, wall finish, flooring &/or furniture together while deciding the theme of decoration, if all they are provided are a few small samples of each materials.

Instead of looking at proper effects, customers have to rely upon their ability to mentally visualize the final effects at the time of decision and payment, which is very uncomfortable situation.

It is extremely difficult for everyone involved in the selection process (as in clients, vendors, designers etc) to always schedule to be able to meet at the same place at the same time OR at the store during store hours to proceed with the selection process. This delays the overall process of transaction.

It is extremely time consuming for the designers and retailers to convince customers of the effects of correct choices using existing conventional means.

It is waste of time and energy for the designers to have to carry loads of fabrics with them while they travel around the town to different client locations for every single meeting.

It is impossible for the vendors at store and designers to be able to show the actual final product in each of available materials to client, as that would require them to hold enormous inventory for each possible alternatives/combinations.

The results of these limitations are decreased productivity of designers and stores, increased transaction time for everyone, inflexibility of time and confusing selection process for clients.

### SUMMARY

The User interface for a display terminal comprising an interface for a plurality of users to simultaneously log in from different locations in a same user account and view centralized selections to communicate their ideas even while each of said plurality of users is located at different locations.

### BRIEF DESCRIPTION OF DRAWINGS

Presented herein are virtual window and room treatments as described and shown in the figures and claims.

FIG. 1 is a block diagram of virtual reality viewer with menus to choose items from and load them in the viewing area;

FIG. 2 is a block diagram of virtual reality viewer displaying how different styles of drapes could be selected to view in the viewing area;

FIG. 3 is a block diagram of virtual reality viewer displaying how to choose and apply pre-selected fabrics on the selected style of drape;

FIG. 4 is a block diagram of virtual reality viewer displaying how different styles of valance/swag etc could be selected to view in the viewing area;

FIG. 5 is a block diagram of virtual reality viewer displaying how to choose and apply pre-selected fabrics on the selected style of valance/swag etc;

FIG. 6 is a block diagram of virtual reality viewer displaying how pre-selected rod knobs can be selected and loaded in the viewing area to view final effects;

FIG. 7 is a block diagram of virtual reality viewer displaying how pre-selected wall covering can be selected and loaded in the viewing area to view final effects;

FIG. 8 is a block diagram of virtual reality viewer displaying how pre-selected wall border can be selected and loaded in the viewing area to view final effects;

FIG. 9 is a block diagram of selection system, where user can choose from the available vendors and by choosing one of them, can view the items of selected item type by this vendor;

FIG. 10 is a block diagram of selection system, where user can either add or remove items to/from his/her/their selections using add and remove buttons;

FIG. 11 is a block diagram of selection system displaying item type tabs on top for user to view specific type of items. The search field is to find items of selected item type, meeting search criteria;

FIG. 12 is a block diagram of selection system displaying how catalogs from selected vendors could be chosen to view items in the selected catalogs meeting the current item type;

FIG. 13 is a block diagram of MySelection page in selection system displaying all items grouped as item type that user selected so far.

### DETAIL DESCRIPTION OF THE DRAWINGS

The system provides an interface and means providing flexibility to communicate and exchange suggestions with everyone involved in selection process even while everyone is at completely different locations.

The system provides a virtual reality view producing combination of three dimensional and two dimensional view of the material samples from multiple suppliers over desired object at appropriate locations in the display region while allowing users to build their existing environment or a new proposed environment.

The system provides robust selection system to view and search through thousands of samples from multiple suppliers in seconds to view and shortlist from only those samples that meet user's criteria and compare them faster.

System is available on-line for the users to be able to use with any web browser without needing to store any data or samples locally.

The system provides means to access authorized data for logged in user account from network by making database connection, transparent to users.

There are three main aspects of system. The first aspect is “Virtual Reality Viewer”. It is a user interface for viewing combination of two-dimensional and three-dimensional views of objects with different surface materials of different material types from multiple view ports.

The second aspect of the system is “Selection System”, used to choose different objects and material samples for using in the “Virtual Reality Viewer”.

Third aspect of the system is the way the data is handled for multiple users belonging to different corporations that have access to different material supplier vendor's data.

Multiple users (Designers, clients and store representatives) can log in to a single client account using unique username and password for the account from completely different locations.

Individual user sessions are maintained without affecting the other user's selection.

Saved selections could be displayed on each individual user sessions by entering the “My Selection” page or refreshing the “My Selection” page in the selection system.

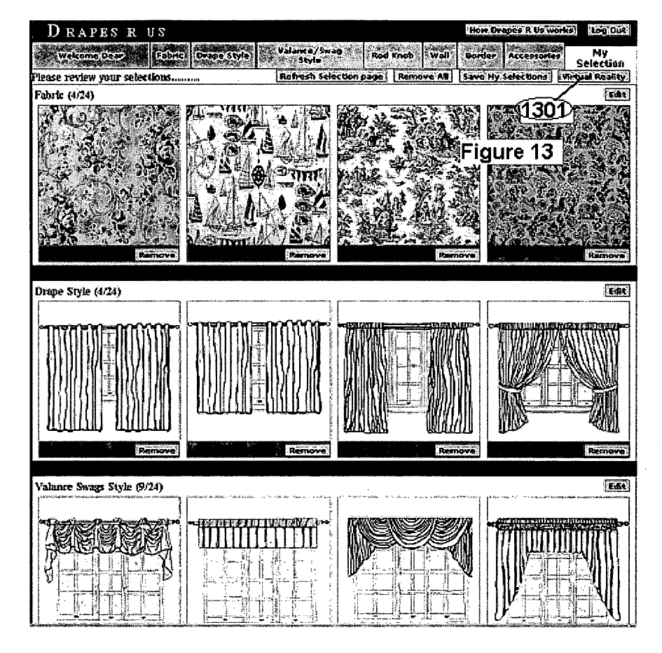

Referring now to FIG. 13, there is illustrated a block diagram of “my Selection” page, from where users can open the “Virtual Reality Viewer” by clicking “Virtual Reality” button 1301.

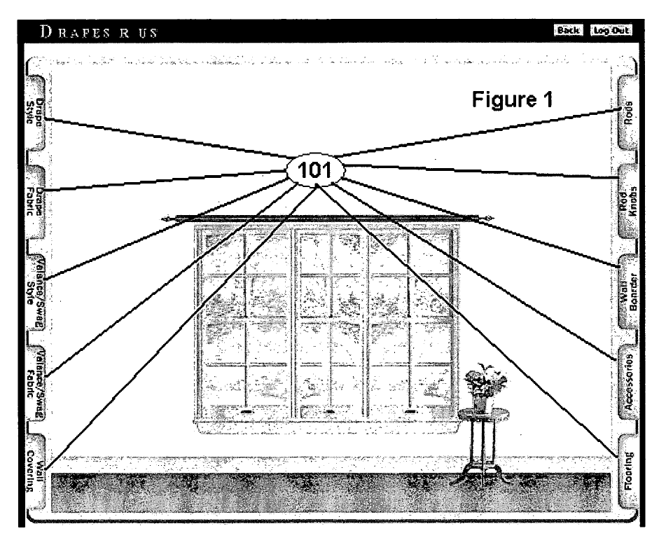

Referring now to FIG. 1, there is illustrated a block diagram of “Virtual Reality Viewer”, where the scrollable rolling out menus 101 are provided in such a way to have minimum intervention of the menus 101 over the view, while users choose different objects and finishes from menus 101.

The individual scrollable menus 101 provided for each item type and objects, hold scrollable item sample list of user selections from the selection system based on item type.

Users can also place their own materials (for e.g. wallpaper from client's room) in the system to generate the ambience of actual location.

Users can choose any of these materials and view all combinations on different objects in the “Virtual Reality Viewer” display region where view is generated with three-dimensional and two-dimensional objects and item samples.

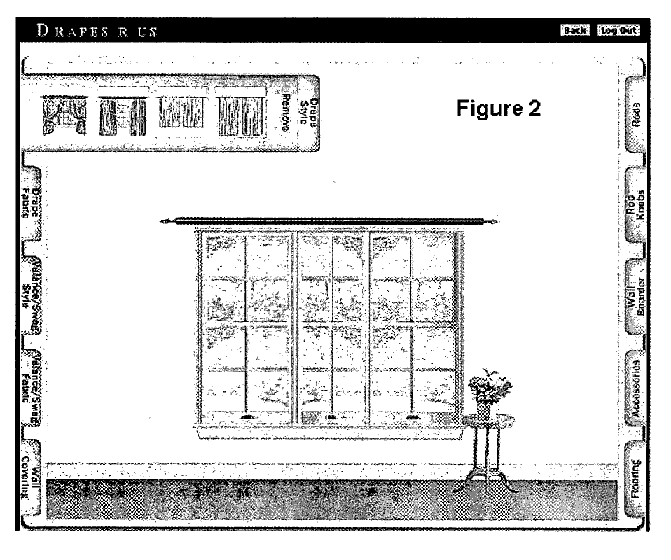

Referring now to FIG. 2, there is illustrated a block diagram of “Virtual Reality Viewer”, where users can select from available style of drapes to view the same type of drape on the window in the central region by clicking on the same.

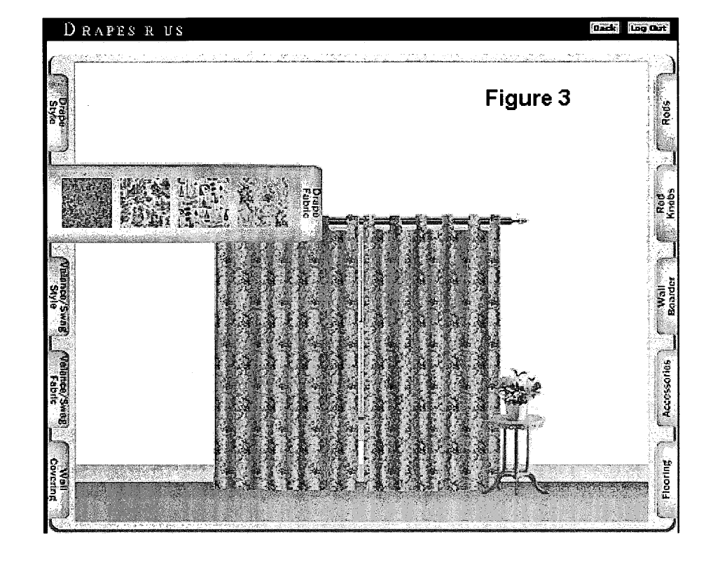

Referring now to FIG. 3, there is illustrated a block diagram of “Virtual Reality Viewer”, where the users can select from any selected drape fabric/materials by clicking on its sample to view the actual drape generated out of the selected sample on selected drape style.

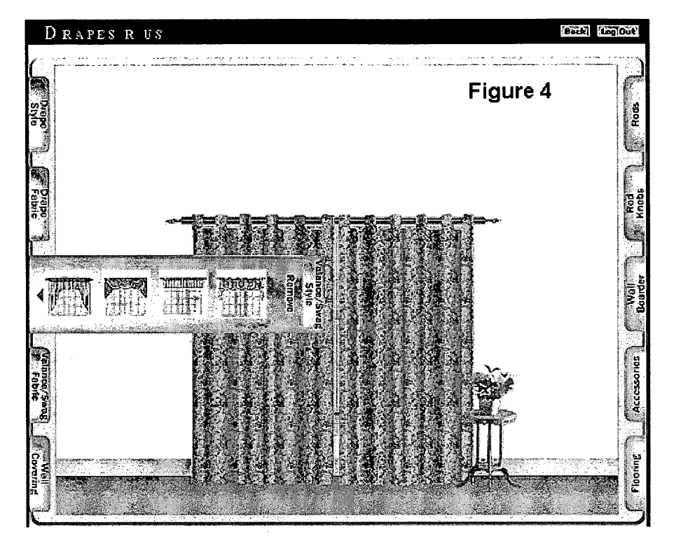

Referring now to FIG. 4, there is illustrated a block diagram of “Virtual Reality Viewer”, where the users can select from available style of valance/swag and other window treatments to view them on the window in the central region by clicking on the same.

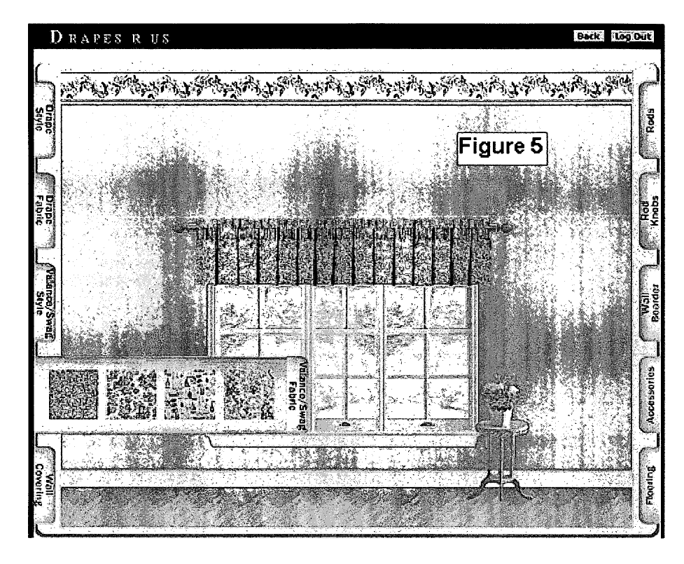

Referring now to FIG. 5, there is illustrated a block diagram of “Virtual Reality Viewer”, where the users can select from any selected valance/swag and other window treatments fabric/materials by clicking on its sample to view the same applied to the selected treatment style generating an actual object out of the selected sample.

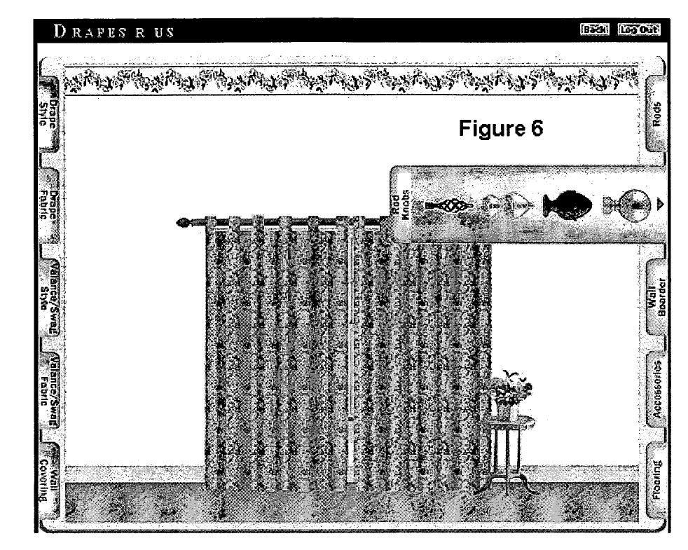

Referring now to FIG. 6, there is illustrated a block diagram of “Virtual Reality Viewer”, where users can put desired hardware on the view for Rod and Rod knobs by using relevant menu 101 and clicking the sample.

Further in the same view, users can apply trims to the selected style of window treatment by choosing appropriate menu 101 and item.

Further in the same view, users can apply various accessories like room furniture, tiebacks, holdings, etc using relevant menus 101.

Further in the same view, users can put any furniture items like chair/sofa etc. . . . by choosing appropriate style of selected furniture item.

Further in the same view, users can apply desired finishing material from the appropriate selected item's menu 101 to view the furniture objects using the same sample material.

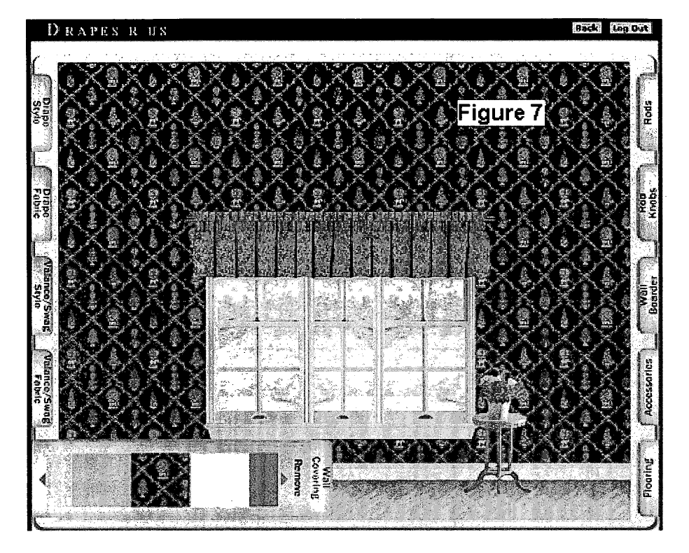

Referring now to FIG. 7, there is illustrated a block diagram of “Virtual Reality Viewer”, where the users can select the wall color/wall paper/wall finish from wall menu 101 to view samples of all such selections made earlier in the system and click on any specific sample to generate the wall finish for the Virtual Reality Viewer room using the same.

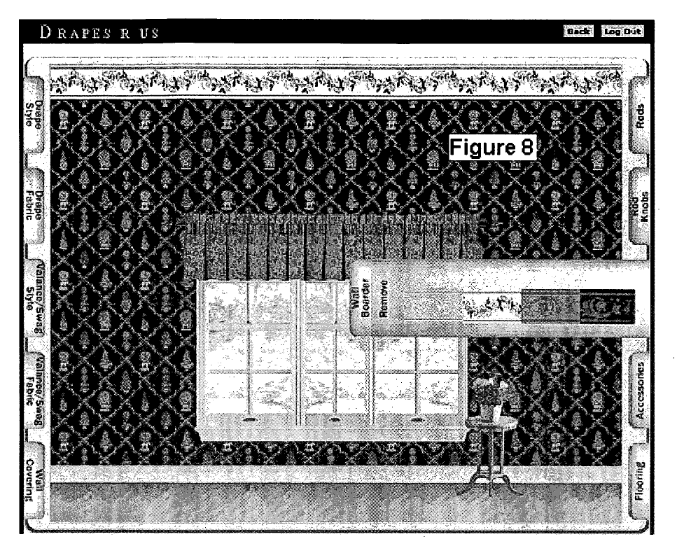

Referring now to FIG. 8, there is illustrated a block diagram of “Virtual Reality Viewer”, where the users can select the wall border from separate wall border menu 101 to view all such selections made earlier in the system by scrolling through the menu 101 items and click on any specific sample to generate the wall finish for the Virtual Reality Viewer room using the same.

Further in the same view, users can remove any object/s &/or item/s by simple clicking remove from the respective menu 101.

Using the same screen users can do as many combinations of different objects and materials as they want.

Means are provided to fetch required two-dimensional and three-dimensional objects and samples as and when user clicks on a particular command button on Virtual Reality Viewer screen. This process is transparent to users.

Users can go back to selection system by click of a “Back” button on top right from the “Virtual Reality Viewer” screen and update their selections for one or more item types. Every time the user comes back to Virtual Reality Viewer screen, a fresh set of selected items is loaded for the users for them to be able to view and communicate the ideas and effects of individual and overall effects.

Different viewpoints and base views could be selected based on user's requirements.

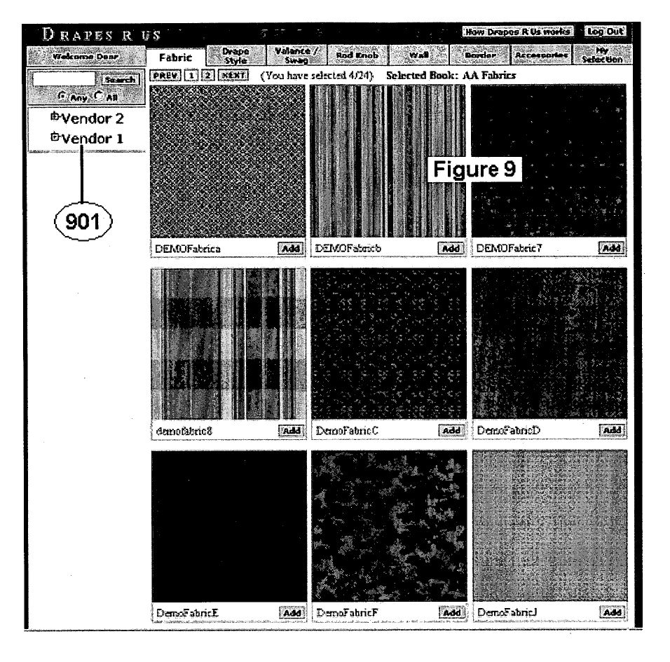

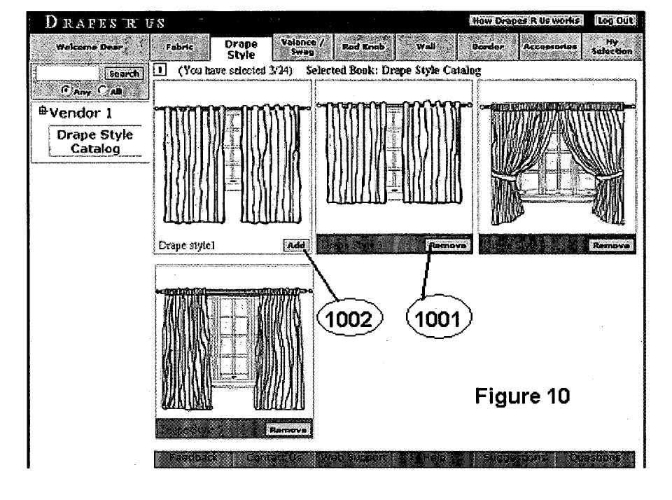

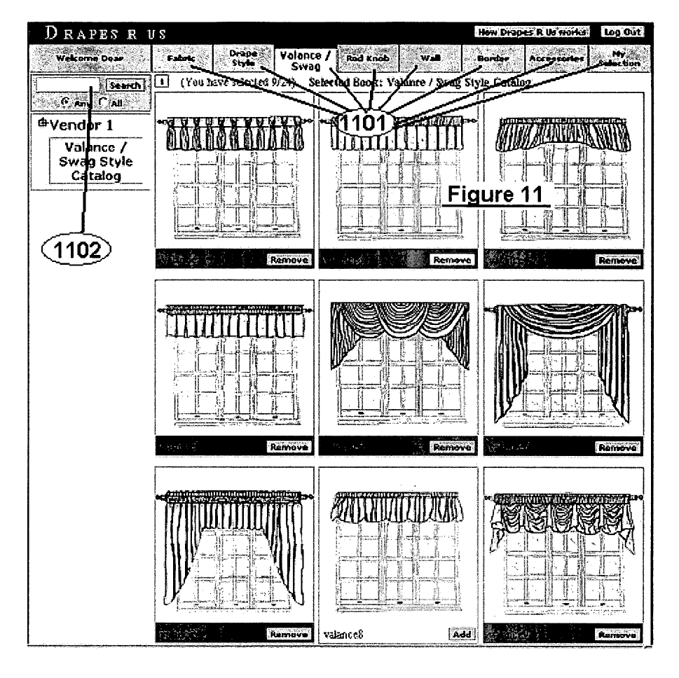

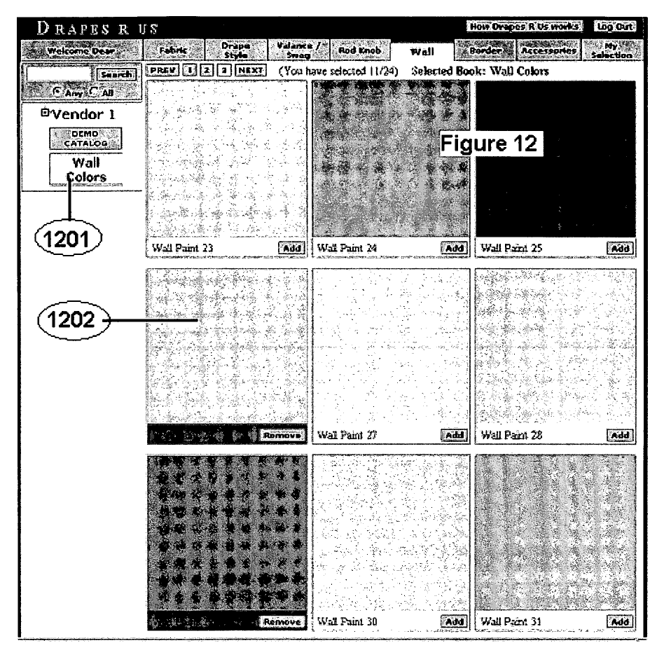

Referring now to FIG. 9, FIG. 10, FIG. 11, FIG. 12 and FIG. 13 there are illustrated block diagrams of “Selection system”, where users can view and choose from available materials and objects and view all selections on single page.

Referring now to FIG. 11, there is illustrated a block diagram of “Selection system”, where user shall view the item type tabs 1101 on top comprising but not limited to Fabric, Drape Style, Valance/Swag style, Wall, Wall Border, Rod Knob, Accessories, My Selections etc. . . . each representing items from the same item type category.

Clicking on any of the tab 1101 shall display the expandable list of vendors 901 on the left pane. For e.g. when user clicks on Fabric tab 1101, the expandable vendor names 901 are listed on left pane as Vendor 1 and 2.

On expanding any of the vendor names 901 from the left pane, the list of available sample books 1201 for this vendor shall be displayed. Referring now FIG. 12, where the list of catalog books 1201 containing Wall covering items 1202 from Vendor 1 are displayed.

On clicking on any of the sample books 1201, user shall view items from this sample book 1202 that are of the selected item tab 1101 type from top, on the right hand side pane of the screen. Referring now FIG. 12, where the items of wall covering type 1202 from the catalog book/sample book named as “Wall Color” 1201 from Vendor 1 spread over 3 pages as mentioned on the page are displayed.

On clicking any item image a separate window with details and larger picture for the item shall populate.

On clicking “Add” button 1002 on any item, the item shall be added to user's personalized selections for current user session. On clicking “Remove” button 1001 on any item, the item shall be removed from user's personalized selection.

Referring now to FIG. 11, there is illustrated a block diagram of “Selection system”, where user can provide search criteria 1102 in the search field in the left pane. All items of current item type that are accessible to the user and meet the search criteria from all available vendor catalogs will be displayed in the right pane in single or multiple pages depending upon number of items retrieved. User can Add and Remove items from this list with same functionality.

Referring now to FIG. 13, there is illustrated a block diagram of “My Selection” tab page of “Selection system”, where On clicking “My selection” Tab 1101 from top, user shall view all items user may have selected so far, including items saved from the previous login sessions.

Referring now to FIG. 13, there is illustrated a block diagram of “My Selection” tab page of “Selection system”, where by clicking the “Save My Selections” button, all items on the screen are saved to current user's personalized selection catalog that the user/s can view now and in their subsequent logins. Clicking the “Refresh Selection Page” refreshes the page with all selections saved so far from the database. This is to communicate between multiple users logged in to the system at the same time.

While communicating remotely (over a phone or other means) with other parties involved in the selection process, all users can login using the same username password to access the same account. The data could be refreshed to other user's session by saving the first user's data and asking the next user/s to go to MySelection page or ask them to hit the refresh button provided on My selection Page if they are already on that page.

Users shall view the name of the corporation they belong to on the top along with a personalized welcome message in the name of account holder.

Clicking on page numbers on top, the user can go to next/previous or the selected page to view items.

User interfaces, flow and data are managed based on access rights based on user credentials, user's role, corporation/s the user belongs to, sample book/s the corporation/s has access to and items held by each sample book.

Each Corporation has an ability to add as many new materials of any available type as they want to for their personalized choice &/or to generate the exact environment of the client site. Each sample/object is stored as an item. Each item belongs to sample book/catalog/catalog book. Each sample book belongs to a Vendor/Supplier.

Corporation/s are the designer or store accounts that will interact with end user client/s. Each Corporation may have access to sample books from various suppliers.

User belongs to one or more corporation/s.

Roles are defines to provide access to various parts of the system. Roles are assigned to each user to force the access rights on each user to certain part/s of the system.

Corporations can change the default names and properties of any item and sample books to personalize the entire selection for their clients and keep the suppliers transparent to their client as well.

Selected item/s and sample book/s can be discontinued for displaying in the system for desired corporation/s or for all depending upon the information from supplier/s or from corporation/s.

The application is built using J2ee specifications. The HTML pages are generated on user's browser using JSP and HTML pages. The application interfaces on web using the application server and web server supporting J2EE web application. Both two-dimensional and three-dimensional objects/samples are displayed in selection system based on the users http requests. The Virtual Reality Viewer uses web browser that has the ability to display Macromedia's Flash technology to generate the view, load both two dimensional and three dimensional samples and objects at desired location in the view area by either clicking the menu item or dragging and dropping the menu items. The J2EE specifications helps reduce the load while allowing users to load ALL of their selection at the same time and build Virtual Reality View to view multiple combinations and compare the effects on the same screen to make the process interactive, interesting and faster then ever.

The system allows everyone to be on the same page without having to mentally imagine any of the selection BY following the principle of “See it to believe it”. It makes the process faster then ever, saves time, increases productivity, improves clarity of selection, reduces the transaction time and clears all issues in material selection process across the board.

Certain embodiments of the present invention can be implemented as a set information handling system equipped with memory that stores instructions that controls the operation information handling system. Additionally, the memory may be a portable memory such as a floppy disk or CD.

What is claimed is:

1. The User interface for a display terminal comprising:
an interface for a plurality of users to simultaneously log in from different locations in a same user account and view centralized selections to communicate their ideas even while each of said plurality of users is located at different locations.

2. The user interface of claim 1, further comprising a graphical user interface for providing three-dimensional and two-dimensional views of objects on a screen, said graphical user interface generating effects of selected samples from a plurality of catalog books by multiple suppliers, in a chosen ambience at appropriate locations for a selected one from a group consisting of window treatment, flooring, wall finish, furniture, and accessories, by applying appropriate effects and shading to materials and objects.

3. The user interface of claim 2, further comprising menus for holding different objects to load in a region of the screen.

4. The user interface of claim 1, further comprising an interface for allowing a user to choose from multiple items of different item types from multiple vendors coupled with the user interface of claim 3 to forward all selected items to the user interface, wherein users can view and compare two and three-dimension effects of said selected items.

5. A user interface of claim 1, in which user can save new selections, remove individual or all selections, view detail of a chosen item and view chosen selections for current as well as subsequent login sessions.

6. A user interface of claim 5, in which item selection interface provides a two dimensional view of samples of at least one objects selected from a group consisting of drapes, valance, swags, trimmings, accessories, and furniture that are loaded in three dimensional form in the viewer.

7. A user interface of claim 5, in which the selected material's data is cached for the user's active session and is passed to subsequent pages, and wherein the same data is used to obtain reference to graphic files to be loaded to a separate screen to view three-dimensional effects.
